(19) United States
(12) Patent Application Publication
(10) Pub. No.: US 2009/0208068 A1
(43) Pub. Date: Aug. 20, 2009

(54) IMAGING APPARATUS WITH IMAGE TRANSMISSION/RECEPTION FUNCTION

(76) Inventor: Manabu TSUNODA, Kyoto (JP)

Correspondence Address: MCDERMOTT WILL & EMERY LLP, 600 13TH STREET, NW, WASHINGTON, DC, 20005-3096, US

(21) Appl. No.: 12/336,197

(22) Filed: Dec. 16, 2008

(30) Foreign Application Priority Data
Feb. 19, 2008 (JP) 2008-037773

(51) Int. Cl. G06K 9/00

(52) U.S. Cl. 382/118

(57) ABSTRACT

A person previously records his or her face data in a face data storage unit. When a face recognizing unit recognizes that another person is shown in image data captured by an imaging unit, the image data is transmitted from an image transmitting/receiving unit to another camera. A receiver's camera, only when a face recognizing unit recognizes that the receiver himself or herself is shown in the image data received by an image transmitting/receiving unit, records the image data into a storage unit.

### BACKGROUND OF THE INVENTION

1. Field of the Invention

The present invention relates to imaging apparatuses, such as a digital camera, a mobile telephone with camera, and the like.

2. Description of the Related Art

As a digital camera or a mobile telephone with camera (hereinafter simply referred to as a camera) has become popular, there is an increasing demand for sharing of image data captured by the camera among a plurality of people. For example, a situation frequently occurs in which a group of people who are friends make a journey together and they shoot themselves at places where they visit. In such a case, when one person shoots his or her friends by his or her own camera, his or her friends want the thus-captured image data more than anybody.

Therefore, there is a conventional technique as follow. A group of people who are friends, when making a journey together, each previously register face data and mail addresses of the other friends into his or her camera. When an image is taken by the camera, it is determined whether or not the face of anybody who is registered in the camera is shown in captured image data. If a registered friend is found in the image, the image data is sent to his or her mail address previously registered in the camera (see Japanese Unexamined Patent Application Publication No. 2006-166408).

### SUMMARY OF THE INVENTION

In the conventional technique above, it is necessary to previously register face data and addresses into each individual camera or perform grouping or transfer of face data between cameras, which require time and effort. In the case of such previous registration, image data can be sent only to particular persons.

Moreover, it is necessary to identify each person shown in image data before sending image data to a particular person. In other words, as the number of persons registered in a camera or the number of persons shown in image data increases, it takes a longer time to identify a person.

An object of the present invention is to solve the problems described above.

Therefore, an imaging apparatus according to an aspect of the present invention includes an imaging unit for executing shooting to obtain image data, a face recognizing unit for recognizing whether or not a person other than a particular person (e.g., an owner of the imaging apparatus) is shown in the image data, and an image transmitting unit for automatically transmitting the image data immediately after shooting if the face recognizing unit recognizes that a person other than the particular person is shown in the image data. The image data may be erased if it is recognized that the particular person is not shown in the image data.

Also, an imaging apparatus according to another aspect of the present invention includes an image receiving unit for receiving image data transmitted from another imaging apparatus, a face recognizing unit for recognizing whether or not a particular person (e.g., an owner of the imaging apparatus) is shown in the image data, and a storage unit for storing the image data if the face recognizing unit recognizes that the particular person is shown in the image data. The image data may be erased if it is recognized that the particular person is not shown in the image data.

According to the present invention, by automatically transmitting captured image data, it is possible to eliminate an operation of a person who performs shooting and transmit image data to an indefinite number of persons.

### BRIEF DESCRIPTION OF THE DRAWINGS

FIG. 1 is a diagram schematically showing an exemplary shooting situation to which the present invention is preferably utilized.

FIG. 2 is a block diagram showing an exemplary configuration of a camera with an image transmission/reception function according to the present invention.

FIG. 3 is a flowchart showing an imaging operation of the camera of FIG. 2.

FIGS. 4A, 4B, 4C and 4D are diagrams showing exemplary screen displays in a face data registration mode.

FIGS. 5A and 5B are diagrams showing exemplary screen displays in an image data recording mode.

FIG. 6 is a diagram showing an exemplary screen display indicating completion of image data transmission.

FIG. 7 is a flowchart showing an operation of the camera of the present invention.

FIG. 8 is a flowchart showing an image data receiving operation of the camera of FIG. 2.

FIG. 9 is a diagram schematically showing another shooting situation.

FIG. 10 is a diagram schematically showing still another shooting situation.

FIG. 11 is a diagram schematically showing still another shooting situation.

FIG. 12 is a diagram schematically showing still another shooting situation.

### DETAILED DESCRIPTION OF THE PREFERRED EMBODIMENTS

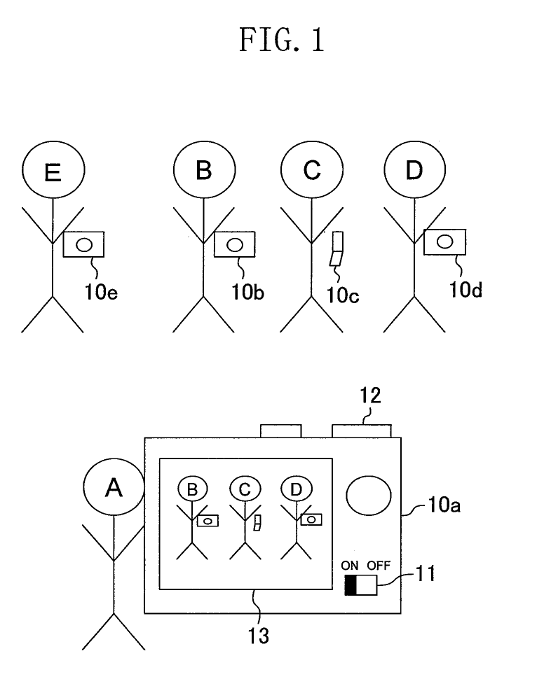

FIG. 1 shows an exemplary shooting situation in which the present invention is preferably utilized. FIG. 1 shows five cameras (a digital camera, a mobile telephone with camera, etc.) 10a, 10b, 10c, 10d and 10e. It is assumed: the camera 10a is possessed by a person A whose face data is previously registered therein; the camera 10b is possessed by a person B whose face data is previously registered therein; the camera 10c is possessed by a person C whose face data is previously registered therein; the camera 10d is possessed by a person D whose face data is previously registered therein; and the camera 10e is possessed by a person E whose face data is previously registered therein. Here, the person A shoots the persons B, C and D using his or her own camera 10a. In this case, if the person A presses a shutter release button 12 provided on the camera 10a while a real-time transmission control switch 11 provided on the camera 10a is ON, it is confirmed that three persons other than the person A who is an owner of the camera 10a are shown in image data displayed on a display screen 13, and the image data is immediately transmitted, according to the present invention. The camera 10b possessed by the person B receives the image data in which the persons B, C and D are shown, confirms that the person B who is an owner of the camera 10b is shown, stores the image data, and outputs a reception completion signal. The cameras 10c and 10d possessed by the persons C and D, respectively, similarly store the image data and output a reception completion signal. Note that camera 10e possessed by the person E receives the image data in which the persons B, C and D, confirms that the person E possessing the camera 10e is not shown, and erases the image data. On the other hand, the camera 10a possessed by the person A receives the reception completion signals from the three cameras 10b, 10c and 10d, thereby confirming that transmission of the image data has been completed.

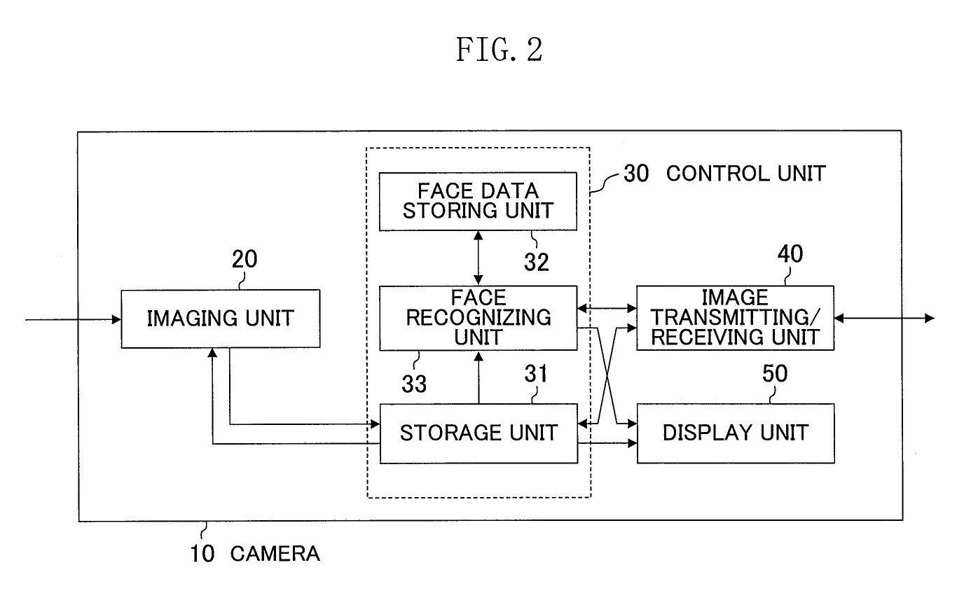

FIG. 2 shows an exemplary internal configuration of a camera 10 that achieves the function described above. In FIG. 2, the camera 10 has an imaging unit 20, a control unit 30, an image transmitting/receiving unit 40, and a display unit 50. The control unit 30 has a storage unit 31 for storing imaging parameters and image data, a face data storage unit 32 for storing, for example, face data of a person who is an owner of the camera 10, and a face recognizing unit 33. The control unit 30 controls the whole camera 10. Note that the display unit 50 corresponds to the display screen 13 of FIG. 1.

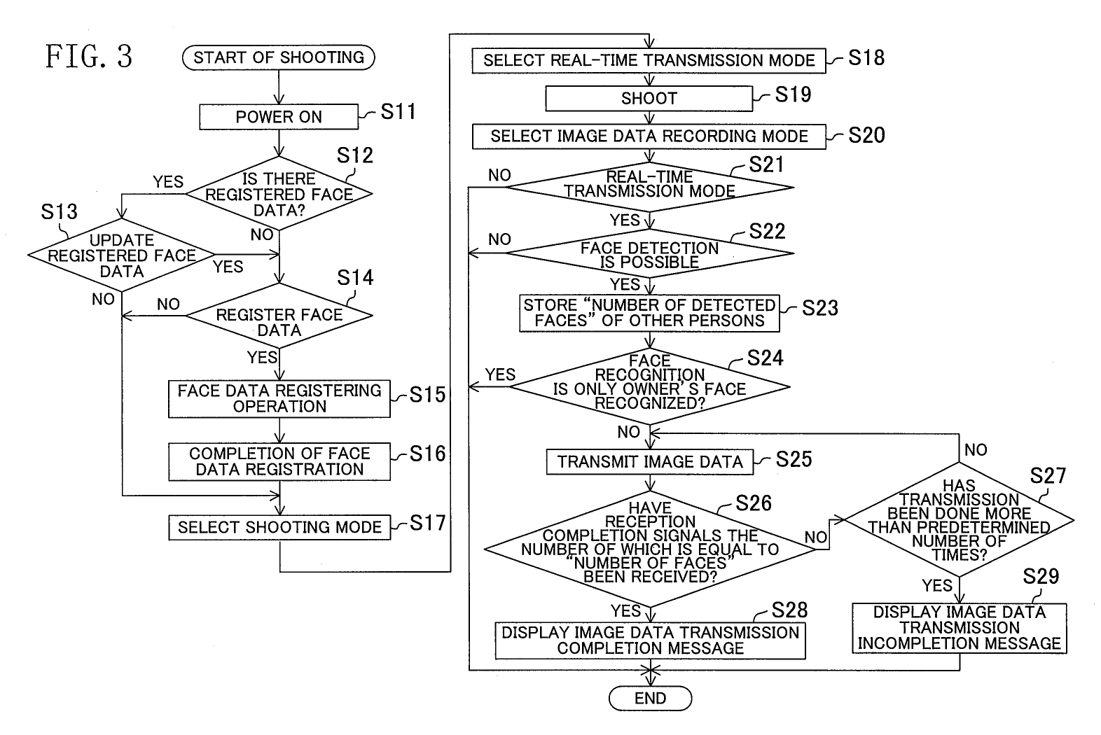

FIG. 3 is a flowchart showing an imaging operation of the camera 10 of FIG. 2. The camera 10 is powered ON in step S11, and thereafter, a face data registration mode is executed in steps S12 to S16. Specifically, it is determined whether or not face data is registered in the face data storage unit 32 (S12). When face data already exists, the user is prompted to determine whether to update the face data (S13). When face data does not exist, the user is prompted to determine whether to register face data (S14). If the user selects registration of face data, the camera 10 goes to a face data registering operation (S15).

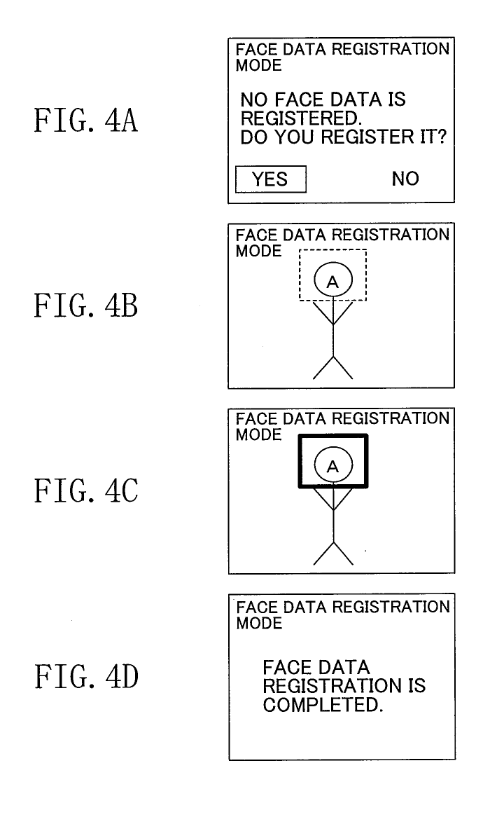

FIGS. 4A to 4D show exemplary screen displays in the face data registration mode. Initially, as shown in FIG. 4A, a selection screen including a message that prompts the user to determine whether to register face data into the camera 10, is displayed on the display unit 50. If the user selects registration of face data, the camera 10 goes to a face data registering operation. As an exemplary registration method, the user is shot by somebody else using the camera 10, and face data is extracted from a captured image and is then registered.

When a person A is shot by the camera 10, a frame for recognizing a face is displayed on the display unit 50 as shown in FIG. 4B. Thereafter, the frame is shifted to the person A whose face data the user want to register. Next, when the user presses the shutter release button, the frame that has been shifted to the person A who the user wants to register is emphasized as shown in FIG. 4C before the face data is registered. When registration of the face data is completed, a message that “face data registration is completed” is displayed as shown in FIG. 4D. Thus, face data registration is completed (S16).

Note that, as another face data registering method, face data may be extracted and recorded from image data that is already captured and recorded in a recording medium, such as an SD card or the like.

After completion of face data registration, a shooting mode is next selected (S17). Depending on the shooting mode selected by the user, parameters corresponding to the shooting mode that are recorded in the storage unit 31 are set into the imaging unit 20. For example, when shooting is performed indoors, the amount of light is likely to be lower than that in an outdoor environment. Therefore, when an indoor shooting mode is selected, an f-number of a lens that is a parameter for adjusting the amount of light is set into the imaging unit 20 so that the amount of light required for indoor shooting is secured. F-number parameters are recorded in the storage unit 31.

Next, when it is confirmed that the real-time transmission control switch 11 is in the ON state, the image transmitting/receiving unit 40 is set to be in a real-time transmission mode (S18). The real-time transmission mode is a mode in which immediately after an image is taken, captured image data is transmitted from the camera 10. The real-time transmission mode is a feature of the present invention. Thereafter, an image is taken (S19).

Note that the method of selecting the real-time transmission mode is not limited to the method of controlling the dedicated switch 11 that is provided as hardware as described above. For example, the real-time transmission mode may be selected from a menu in a GUI screen displayed in the display screen 13.

Next, an image data recording mode is selected (S20). Here, it is determined whether or not the obtained image data is to be recorded into the camera 10 itself

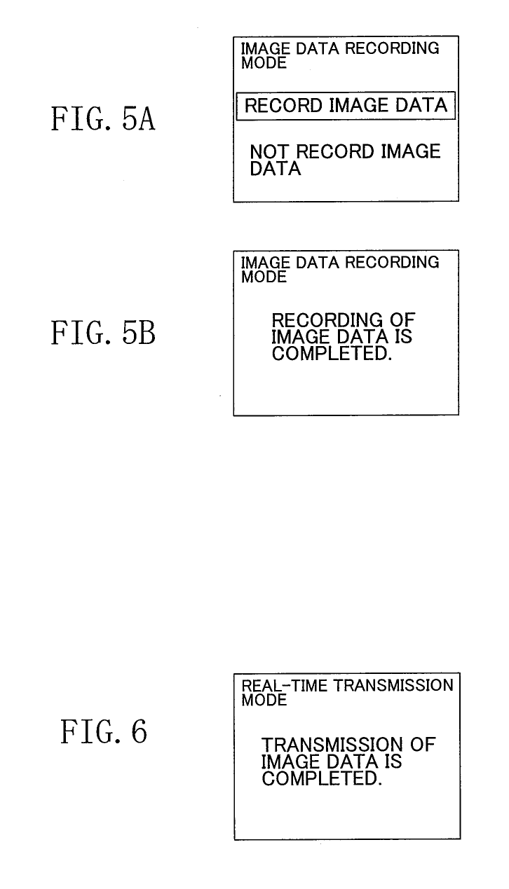

FIGS. 5A and 5B show exemplary screen displays in the image data recording mode. As shown in FIG. 5A, a GUI screen is displayed, prompting the user to determine whether to record image data. When the user selects “record”, a message “record image data” is emphasized. Finally, the image data captured by the imaging unit 20 is recorded into the storage unit 31, and thereafter, a message indicating that recording has been normally done is displayed as shown in FIG. 5B.

Next, it is determined whether or not the current mode is the real-time transmission mode (S21). Only when the current mode is the real-time transmission mode, operations of steps S22 to S29 are executed. Initially, the face recognizing unit 33 reads out image data from the storage unit 31, and determines whether or not a human face exists in the captured image data (S22). If a human face exists in the captured image data, the face recognizing unit 33 determines whether or not the face of a person shown in the image data matches the face data of a person (the owner of the camera 10) recorded in the face data storage unit 32, and stores the number of faces other than the face of the owner of the camera 10 (S23). When the face recognizing unit 33 recognizes that a person other than the owner of the camera 10 is shown in the captured image data (S24), the image transmitting/receiving unit 40 transmits the image data (S25). The camera 10 receives a reception completion signal notifying that the transmitted image data has been successively received by a camera possessed by the person shot by the camera 10. When it is confirmed that the number of faces recognized by the face recognizing unit 33 is equal to the number of reception completion signals thus received (S26), a message indicating completion of image data transmission is displayed on the display unit 50 as shown in FIG. 6 (S28). Even if the camera 10 transmits image data a predetermined number of times, the image data may fail to be received by a camera possessed by another person shot by the camera 10 (S27). In this case, a message indicating that transmission of the image data has not been completed is displayed on the display unit 50 (S29).

An exemplary function and internal configuration of the camera 10 have been described above. Next, a series of operations that the person A performs with respect to the camera 10a will be described.

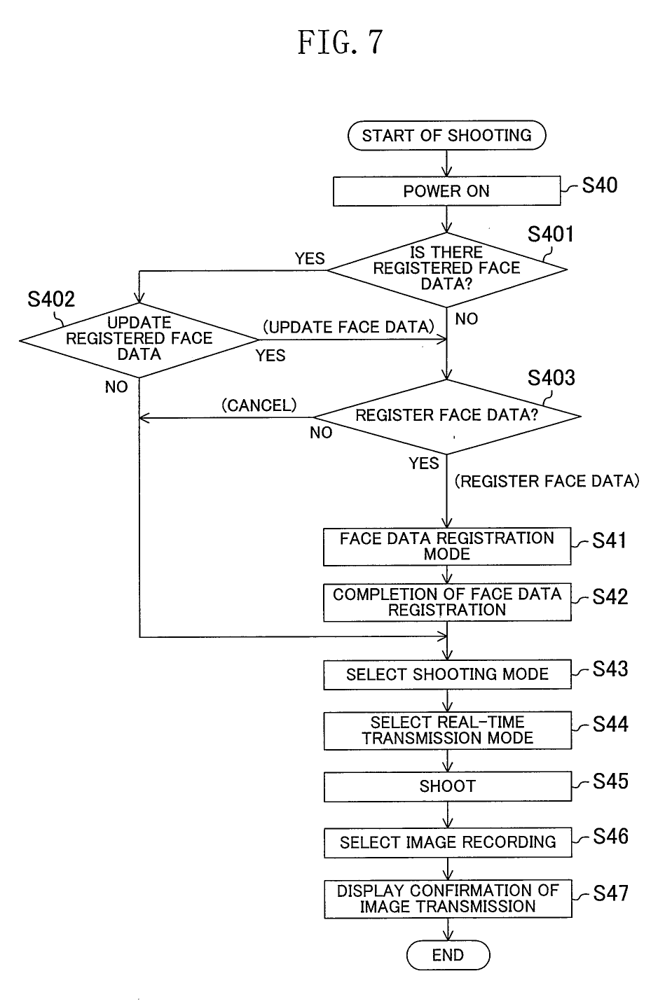

FIG. 7 shows a flowchart of camera operations. The person A who is to take an image initially powers ON the camera 10a (S40), and then determines whether to register face data in accordance with an instruction from the camera 10a (S401, S402, S403). When the person A selects registration of face data, the person A selects the face data registration mode (S41) and completes registration of face data (S42). When the person A cancels registration of face data, the person A immediately goes to selection of a shooting mode that is similar to that of the conventional art (S43).

Next, the person A selects the real-time transmission mode (S44). The real-time transmission mode is a mode in which, immediately after an image is captured, the captured image data is transmitted from the camera 10a, which is a feature of the present invention. To select the real-time transmission mode, the person A switches ON the real-time transmission control switch 11 provided on the camera 10a as shown in FIG. 1. Next, the person A presses the shutter release button 12 to shoot the persons B, C and D (S45). Next, the person A determines whether to record captured image data into his or her camera 10a (S46). As shown in FIG. 5A, a GUI screen that prompts the user to determine whether to record captured image data is displayed in the display screen 13, and the person A who is an owner of the camera 10a selects “record” or “cancel”. If the image data is normally recorded, a message as shown in FIG. 5B is displayed in the display screen 13. The captured image data is immediately transmitted from the camera 10a. If reception of the image data transmitted from the camera 10a is completed, a message as shown in FIG. 6 notifying transmission completion is displayed in the display screen 13 of the camera 10a (S47). The person A then ends shooting. An operation procedure carried out by a person who performs shooting has been described above.

In the situation of FIG. 1, even if the camera 10a of the person A tries to transmit image data a predetermined number of times, all of the cameras 10b, 10c and 10d of the persons B, C and D may fail to receive the image data, i.e., the camera 10a of the person A may receive none of three reception completion signals, the image data should be maintained in the storage unit 31 without being erased.

Also, in the situation of FIG. 1, all of the persons B, C and D have their cameras. A person who does not possess a camera may be shown in image data. In this case, the image data should also be maintained in the camera 10a of the person A as in the case where no reception completion signals are received.

Incidentally, in the situation of FIG. 1, the persons B, C and D are shown in the image data captured by the person A, but the person A who captured the image data is not shown in the image data. A person may consider that image data is not necessary if the person himself or herself is not shown in the image data. In this case, the image data stored in the storage unit 31 may be erased. If this function is implemented, unnecessary image data is not recorded, so that the memory capacity of the storage unit 31 can be efficiently used, and since unnecessary data is not recorded, it is possible to avoid time and effort to organize pieces of recorded image data. A function of allowing the user to determine whether image data in which the user himself or herself is not shown is to be automatically erased, may be provided.

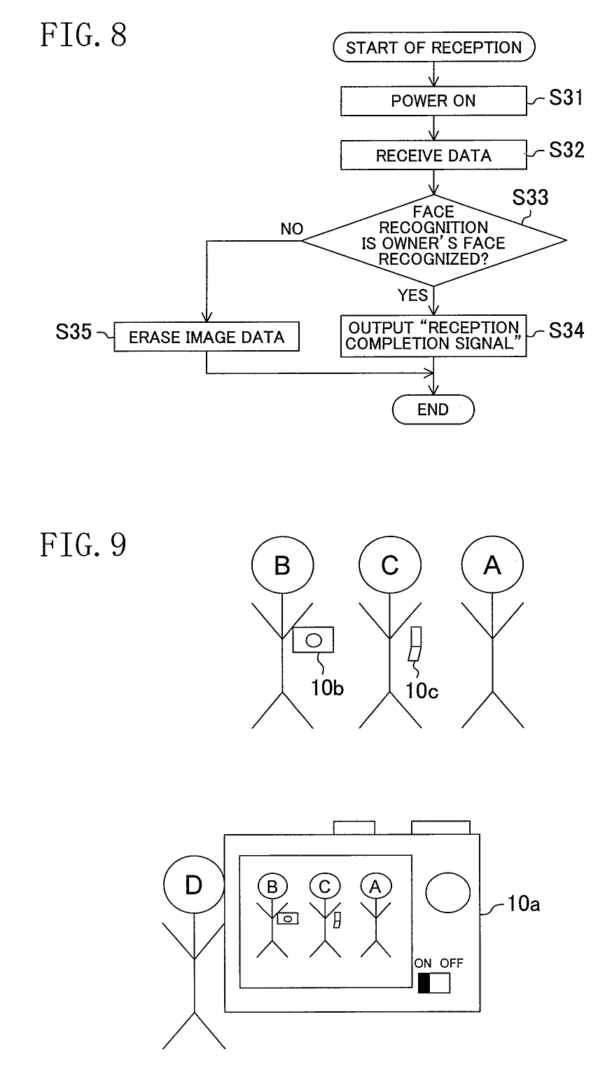

FIG. 8 is a flowchart showing an image data receiving operation of the camera 10 of FIG. 2. Initially, the camera 10 is powered ON (S31). After being powered ON, the camera 10 is automatically transitioned to a state in which the camera 10 can receive image data. Next, the camera 10 receives image data from another camera (S32). The image data received by the image transmitting/receiving unit 40 is stored into the storage unit 31. The camera 10 determines whether or not the face of a person who is an owner of the camera 10 is shown in the image data received in the face recognizing unit 33 (S33). If the face of the person is shown in the image data, reception of the image data is completed, and therefore, a reception completion signal is output (S34). On the other hand, when the face of the person is not shown in the received image data, the image data stored in the storage unit 31 is erased (S35). In other words, although image data is transmitted from a person to an indefinite number of other persons, the image data cannot be received by non-related persons.

FIGS. 9 to 12 show other shooting situations. Other operations of a camera will be described with reference to these figures.

As shown in FIG. 9, a case where the person A passes his or her camera 10a to the person D, who in turn shoots the persons A, B and C, will be described. The cameras 10a, 10b and 10c held by the persons A, B and C previously record face data of the camera owners A, B and C, respectively. Image data that is captured by the person D using the person A's camera 10a is recorded into the storage unit 31. Next, the face recognizing unit 33 reads out the image data from the storage unit 31, and determines whether or not a human face exists in the captured image data. In the example of FIG. 9, the faces of three persons are recognized. Next, it is determined whether or not the face of the person A is included in these faces. In other words, the persons shown in the image data are successively identified. In the example of FIG. 9, it is recognized that the persons A, B and C are shown in the image data. Next, the image data is transmitted by the image transmitting/receiving unit 40. The image data transmitted from the camera 10a of the person A is received by the cameras 10b and 10c of the persons B and C in accordance with the procedure shown in the flowchart of FIG. 8. On the other hand, the camera 10a of the person A confirms that the number of faces recognized by the face recognizing unit 33 other than the face of the person A is equal to the number of reception completion signals, and completes the transmission operation. Thereafter, for example, in the camera 10a of the person A, the image data recorded in the storage unit 31 is maintained without being erased since the image data in which the person A himself or herself is shown is necessary.

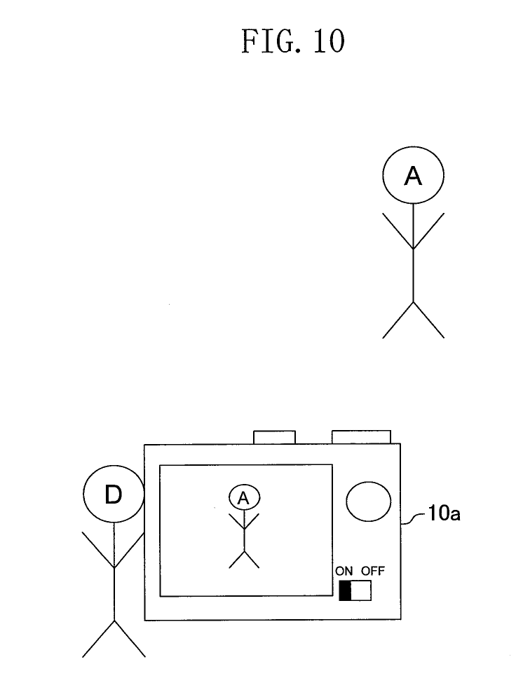

Next, as shown in FIG. 10, an operation when the person A passes his or her camera 10a to the person D, who in turn shoots the person A, will be described. In the camera 10a possessed by the person A, the face data of the owner A is previously recorded. Image data captured by the person D is recorded into the storage unit 31. Next, the face recognizing unit 33 reads out the image data from the storage unit 31, and determines whether or not a human face exists in the captured image data. In the example of FIG. 10, the face of only one person is recognized. Next, it is determined whether or not the face is of the person A. In other words, a person who is shown in the image data is identified. In the example of FIG. 10, it is recognized that the person A is shown in the image data. Since it is recognized that only the owner A of the camera 10a that was used for shooting is shown, the captured image data is not transmitted.

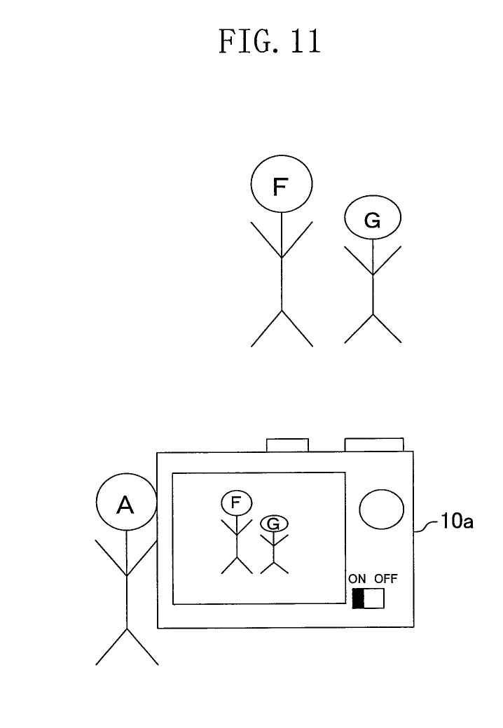

Next, as shown in FIG. 11, a case where the person A shoots his or her family members F and G using the camera 10a possessed by the person A, will be described. It is assumed that face data of the owner A and his or her family members F and G is previously recorded in the camera 10a of the person A. Image data captured by the person A is recorded into the storage unit 31. Next, the face recognizing unit 33 reads out the image data from the storage unit 31, and determines whether or not a human face exists in the captured image data. In the example of FIG. 11, the faces of two persons are recognized. Next, it is determined whether or not these faces are of the persons A, F and G. Specifically, the persons shown in the image data are successively identified. In the example of FIG. 11, it is recognized that the person F and G are shown in the image data. Therefore, since the persons shown in the image data are all previously recorded in the camera 10a of the person A, the captured image data is not transmitted.

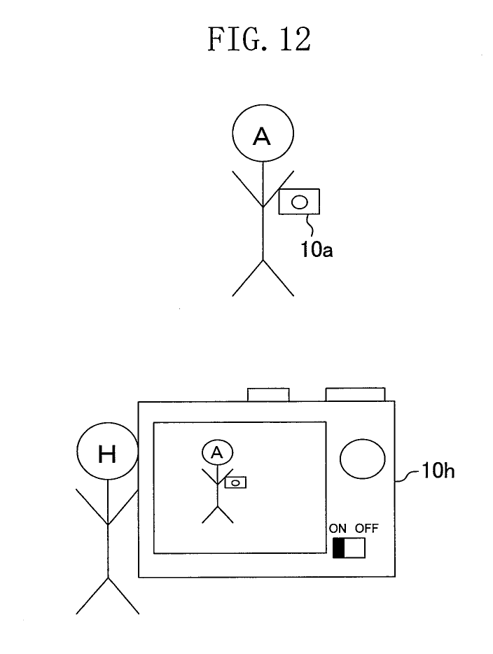

Finally, a case where the person A asks a stranger person H to shoot the person A using a camera 10h possessed by the person H as shown in FIG. 12, will be described. The cameras 10a and 10h held by the persons A and H previously record face data of the owners A and H of their cameras, respectively. Image data captured by the person H is recorded into the storage unit 31. Next, the face recognizing unit 33 reads out the image data from the storage unit 31, and determines whether or not a human face exists in the captured image data. In the example of FIG. 12, the face of a person is recognized. Next, it is determined whether or not the recognized face is of the person H. In other words, the person shown in the image data is identified. In the example of FIG. 12, it is recognized that the person A who is not the person H is shown in the image data. Therefore, since the person shown in the image data is one other than persons previously recorded in the camera 10h of the person H, the image data is transmitted. The image data is received by the camera 10a of the person A. Thus, by carrying out the function of the present invention, the person A can acquire image data obtained by shooting him or her without passing his or her camera 10a to the stranger person H.

As described above, the imaging apparatus of the present invention can automatically transmit captured image data to an indefinite number of persons without the user's operation, and therefore, is useful for a digital camera, a mobile telephone with camera, and the like.

What is claimed is:

1. An imaging apparatus comprising:
an imaging unit for executing shooting to obtain image data;
a face recognizing unit for recognizing whether or not a person other than a particular person is shown in the image data; and
an image transmitting unit for automatically transmitting the image data immediately after shooting if the face recognizing unit recognizes that a person other than the particular person is shown in the image data.

2. The imaging apparatus of claim 1, wherein
the image data is erased if it is recognized that the particular person is not shown in the image data.

3. An imaging apparatus comprising:
an image receiving unit for receiving image data transmitted from another imaging apparatus;
a face recognizing unit for recognizing whether or not a particular person is shown in the image data; and
a storage unit for storing the image data if the face recognizing unit recognizes that the particular person is shown in the image data.

4. The imaging apparatus of claim 3, wherein
the image data is erased if it is recognized that the particular person is not shown in the image data.
